(19) United States
(12) Patent Application Publication
(10) Pub. No.: US 2008/0301811 A1
(43) Pub. Date: Dec. 4, 2008

(54) System For Stabilizing of Web Service and Method Thereof

(76) Inventor: Sung Wook Jung, Seoul (KR)

Correspondence Address: PARK LAW FIRM, 3255 WILSHIRE BLVD, SUITE 1110, LOS ANGELES, CA, 90010, US

(21) Appl. No.: 12/158,846

(22) PCT Filed: Mar. 9, 2007
(86) PCT No.: PCT/KR2007/001172

§ 371 Date: Jun. 23, 2008

(30) Foreign Application Priority Data
Mar. 9, 2006 (KR) 10-2006-0022292
Mar. 9, 2007 (KR) 10-2007-0023274

(51) Int. Cl. G06F 21/00

(52) U.S. Cl. 726/23; 726/22

(57) ABSTRACT

An object of the present invention is to provide a system and method for stabilizing a web service. The system of the present invention includes a reception module unit (410) for receiving set information and cookie information. A cookie information checking module unit (420) determines whether a malicious click occurs in the visitor terminal using the cookie information and the set information. A transmission module unit (430) transmits an operation scenario to the web service server, and transmits detailed information about an abnormal visitor to the manager terminal. A database unit (440) stores the set information and the cookie information. A control module unit (450) compares the cookie information with the set information, creates new cookie information when the visitor is a first-time visitor, determines whether a malicious click occurs, and interrupts access of the visitor terminal or forcibly connects the visitor terminal to a specific site.

### TECHNICAL FIELD

The present invention relates, in general, to a system for stabilizing a web service and, more particularly, to a system and method for stabilizing a web service, which can identify a visitor in an IP address area by calculating the bit rate of the IP address area using IP information about a web browser visitor who accesses a web server system using a World Wide Web (WWW) in the web, thus preventing users' abnormal clicks.

### BACKGROUND ART

Generally, in relation to an Internet advertisement billing system for charging a fee to an advertiser based on the number of clicks using cookie information issued in an Internet visitor terminal, a plurality of patents as well as Korean Patent Laid-Open Publication No. 2006-0103035 entitled an “Internet advertisement billing method and system” (hereinafter referred to as a “prior patent”) was filed.

As shown in FIG. 1, the prior patent is constructed to issue a first cookie, in which an identifier and an issue time are recorded with respect to the access of an Internet user to a web site having an advertisement posted thereon, to the terminal of the Internet user, and to prevent billing from being processed if the issue time recorded on the issued first cookie does not exceed a predetermined time when advertisement click information is received. That is, the prior patent is constructed such that, if it is determined that the issue time recorded on the issued first cookie has exceeded the predetermined time, a second cookie set to charge a fee for repeated clicks only once within a session interval is issued to the Internet visitor terminal, and such that, if the posted advertisement is clicked within the session interval, billing is not processed. Accordingly, since billing is determined after a predetermined time has elapsed from the time point at which the Internet user initially accesses the site, reasonable billing processing is executed even in the case of intentionally repeated clicks caused by the deletion or edition of cookies, and, in addition, a fee is charged only once even though repeated clicks occur within a preset session interval, so that the unreasonable payment of advertisement costs by an advertiser can be prevented.

However, the prior patent is problematic in that, since a predetermined session interval is set, it is difficult to cope with abnormal clicks performed at long-term periods longer than 24 hours by a competitor or a malicious user, thus interrupting the provision of a service due to repeated clicks.

This may result in the situation of service interruption due to the congestion of intentional accesses by which the number of accesses to a web page is excessively large for a short period or long period because the prior patent is limited only to a session interval as a preventive measure for an access to a web page.

### DISCLOSURE

### Technical Problem

Accordingly, the present invention has been made keeping in mind the above problems occurring in the prior art, and an object of the present invention is to provide a system and method for stabilizing a web service, which can identify a visitor in an IP address area even when the cookie of a web browser is deleted or even when an IP address is changed, by calculating the bit rate of the IP address area using IP information about a web browser visitor who accesses a web server system using a World Wide Web (WWW) in the web, thus preventing users' abnormal clicks.

Another object of the present invention is to define the number of accumulative accesses within a specific period, so that a user is forcibly moved to a specific site or a corresponding web service is interrupted when the number of accesses by the user exceeds the number of accumulative, accesses, thus preventing the occurrence of a service interruption caused by the congestion of the access of users.

A further object of the present invention is to define the number of accumulative accesses within a specific period according to an access path to a web site, thus separately managing a normal visitor and an abnormal visitor.

### Technical Solution

In order to accomplish the above objects, the present invention provides a system for stabilizing a web service, the system including at least one visitor terminal (100), each running a web browser to access a web site over an information network (N), a management terminal (200) for managing the web site, a web service server (300) for providing a web site service to allow the visitor terminal to be provided with information, and a web stabilization server (400), wherein the web stabilization server (400) comprises a reception module unit (410) for receiving set information from the manager terminal, and cookie information, included in a web browser of a visitor, from the web service server (300); a cookie information checking module unit (420) for determining whether a malicious click occurs in the visitor terminal using the cookie information and the set information; a transmission module unit (430) for transmitting an operation scenario, corresponding to a case where a number of accesses exceeds a limit number of accesses within a specific period, to the web service server so that the visitor terminal can identify the operation scenario, and transmitting detailed information about an abnormal visitor to the manager terminal; a database unit (440) for storing therein the set information received from the manager terminal and the cookie information received from the web service server; and a control module unit (450) for controlling the components (410, 420, 430 and 440) to run a script for tracking and preventing abnormal clicks, comparing the cookie information with the set information, creating new cookie information when the visitor is a first-time visitor, determining whether a malicious click occurs when the visitor is a returning visitor, and interrupting access of the visitor terminal or forcibly connecting the visitor terminal to a specific site if it is determined that a malicious click occurs.

Preferably, the set information may include a specific period, a limit number of accesses within the specific period, operation scenarios for respective numbers of excessive accesses, weights for respective access paths, Internet Protocol (IP) address areas, and initialization times for the IP address areas so as to prevent payment of improper advertisement costs and interruption of the web service occurring due to repeated clicks or repeated accesses of a competitor or a malicious user, and the cookie information may include an IP address, IP address area information, an address of an accessed web site, an access time (date), and a number of accesses to the web site.

Preferably, the cookie information checking module unit (420) may comprises a cookie information determination module (421) for determining whether an access of the visitor terminal to the web site is an access of a returning visitor, based on the cookie information and the set information; a cookie information creation module (422) for newly creating cookie information of the visitor terminal when the access of the visitor terminal is an access of a first-time visitor; a access number checking module (423) for determining whether the number of accesses included in the cookie information exceeds the limit number of accesses within the specific period according to a condition of the predefined set information when the access of the visitor terminal is not an access of a first-time visitor; a scenario operation module (424) for executing an operation scenario, corresponding to a weight for an access path and a number of excessive accesses when the number of accesses exceeds the limit number of accesses through determination of the access number checking module; an IP address area comparison calculation module (426) for calculating a bit rate of an IP address area based on the IP address and the IP address area information included in the cookie information and the predefined set information; an initialization module (427) for operating a timer to initialize an IP address area having the number of accesses exceeding the limit number of accesses within the specific period; and a visitor management module (428) for recording detailed information about the visitor terminal, including an access time (date), an IP address, and the number of accesses and transmitting the detailed information to the manager terminal through email so that the manager can separately manage the visitor terminal having the number of accesses exceeding the limit number of accesses within the specific period, thus separately managing a normal visitor and an abnormal visitor.

In addition, the present invention provides a method of stabilizing a web service using the system for stabilizing a web service, disclosed in claim 1, comprising the steps of (a) a web stabilization server (300) running a JavaScript by allowing a visitor terminal (100) to access a web service server (300); (b) the web stabilization server checking cookie information of the visitor terminal, which accesses the web service server; (c) the web stabilization server comparing the cookie information with set information, thus determining whether the access of the visitor terminal is an access of a first-time visitor; (d) the web stabilization server checking a limit number of accesses within a specific period corresponding to a weight for an access path if it is determined that the access of the visitor terminal is not an access of a first-time visitor at step (c), and determining whether the number of accesses of the visitor terminal exceeds the limit number of accesses; (e) the web stabilization server executing a corresponding operation scenario according to operation scenarios for respective numbers of excessive accesses if it is determined that the number of accesses exceeds the limit number of accesses within the specific period at step (d); and (f) the web stabilization server calculating an IP address area corresponding to a preset weight for the access path using an IP address and IP address area information of an abnormal visitor terminal (100).

Preferably, the method may further comprise, before the step (a), the step of a manger terminal (200) defining the set information required to prevent payment of improper advertisement costs and interruption of a web service.

Preferably, the step (e) may comprise the steps of a scenario operation module (424) transmitting a warning message to an abnormal visitor terminal through a pop-up window; and the scenario operation module forcibly moving the abnormal visitor terminal to a specific page.

Preferably, the step (f) may comprise the steps of (f-1) the web stabilization server storing cookie information of the abnormal visitor terminal; (f-2) the web stabilization server calculating a bit rate of the IP address area; (f-3) the web stabilization server identifying the corresponding visitor using the calculated bit rate of the IP address area; and (f-4) the web stabilization server initializing the IP address area of the abnormal visitor terminal.

### DESCRIPTION OF DRAWINGS

FIG. 1 is a flowchart showing the billing processing procedure of a conventional Internet advertisement billing system;

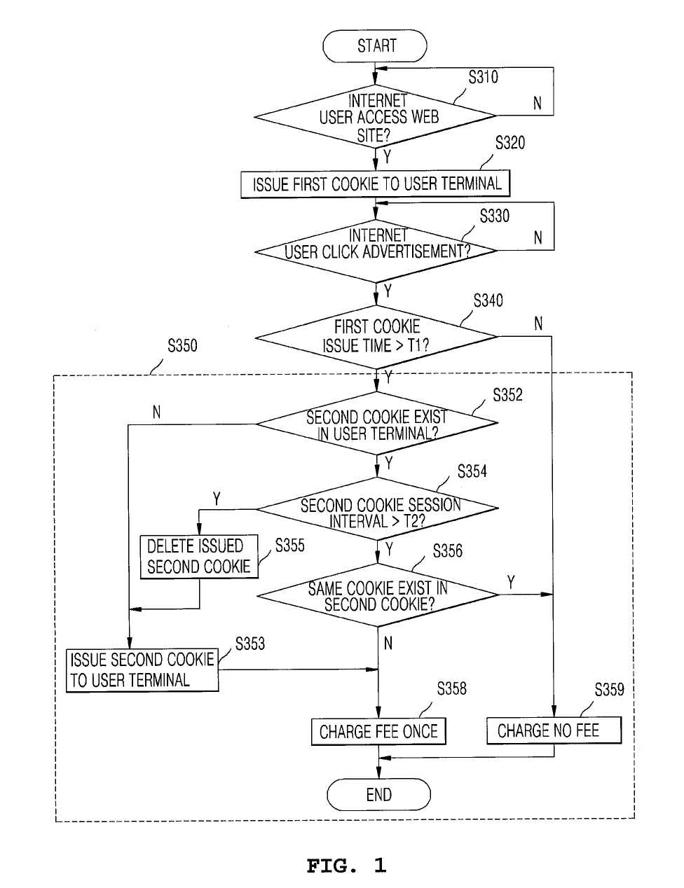

FIG. 2a is a diagram showing the construction of a system for stabilizing a web service according to an embodiment of the present invention;

FIG. 2b is a block diagram of a system for stabilizing a web service according to an embodiment of the present invention;

FIG. 3 is a diagram showing IP address classes according to an embodiment of the present invention;

FIG. 4a is an entire flowchart of a method of stabilizing a web service according to an embodiment of the present invention; and

FIG. 4b is a detailed flowchart showing the step of calculating an IP address area according to an embodiment of the present invention.

### DESCRIPTION OF REFERENCE CHARACTERS OF IMPORTANT PARTS

100: visitor terminal
200: manager terminal
300: web service server
400: web stabilization server
410: reception module unit
420: cookie information checking module unit
421: cookie information determination module
422: cookie information creation module
423: access number checking module
424: scenario operation module
425: cookie information recording module
426: IP address area comparison calculation module
427: initialization module
428: visitor management module
430: transmission module unit
440: database module unit
450: control module unit

### BEST MODE

The features and advantages of the present invention will be more clearly understood from the following detailed description taken in conjunction with the accompanying drawings. Before the description thereof, the terms and words used in the present specification and claims should be interpreted as the meaning and concept coincident with the technical spirit of the present invention on the basis of a fundamental rule that an inventor can suitably define the concept of corresponding terms to describe his or her invention using the best method. Further, it should be noted that, if it is determined that a detailed description of well-known functions and constructions related to the present invention unnecessarily makes the gist of the present invention unclear, the detailed description is omitted.

Hereinafter, embodiments of the present invention will be described in detail with reference to the attached drawings.

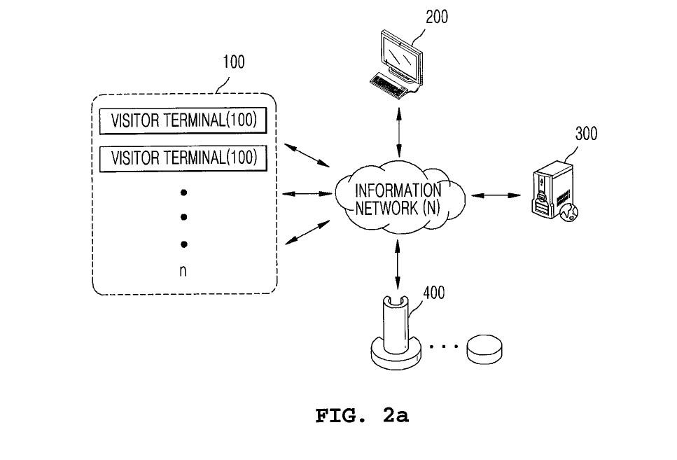

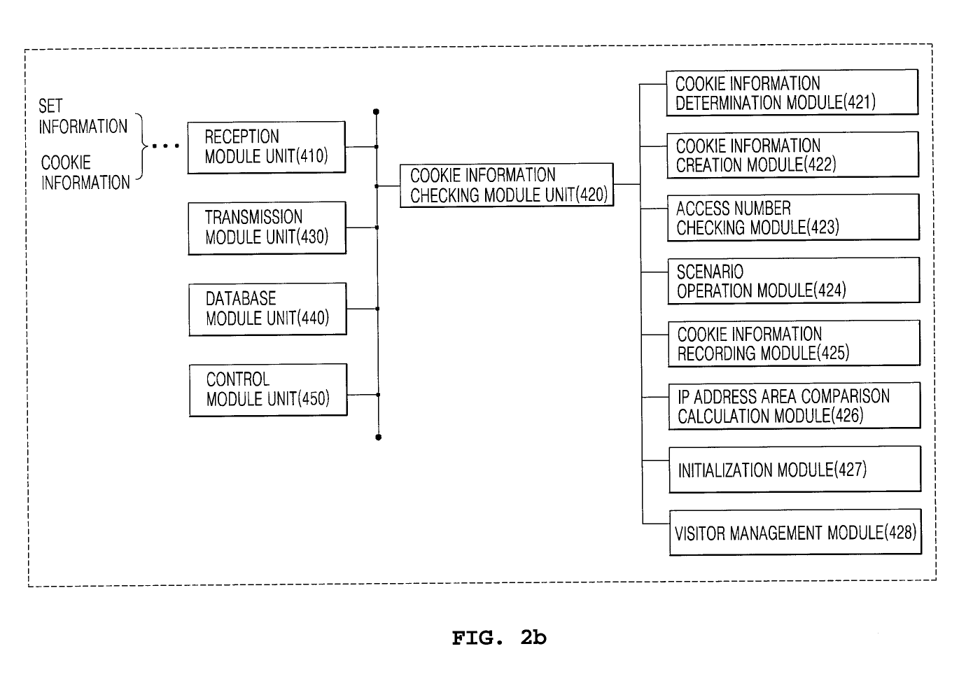

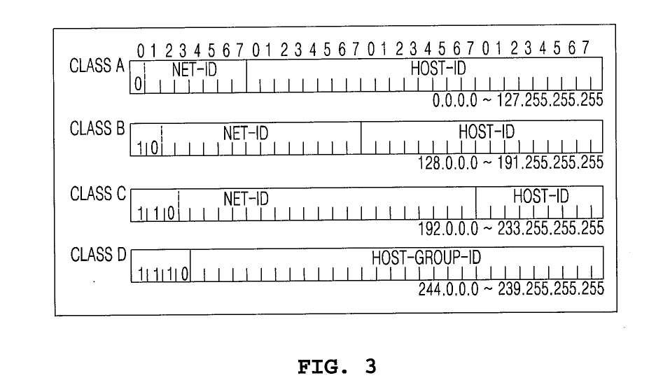

The structure and characteristics of a system for stabilizing a web service according to an embodiment of the present invention are described in detail with reference to FIGS. 2a to 3.

FIG. 2a is a diagram showing the construction of a system for stabilizing a web service according to an embodiment of the present invention, FIG. 2b is a block diagram showing a system for stabilizing a web service according to an embodiment of the present invention, and FIG. 3 is a diagram showing IP Address classes according to an embodiment of the present invention.

First, referring to FIG. 2a, the web service stabilization system according to an embodiment of the present invention includes an information network N, visitor terminals 100, a manager terminal 200, a web service server 300, and a web stabilization server 400.

In this case, a plurality of visitor terminals 100 runs a web browser and thus accesses a web site provided by the web service server 300 through the information network N.

Further, the manager terminal 200 provides a service to allow the web browsers of the visitor terminals 100 to access the web site provided by the manager terminal and to search for information or access a link for corresponding information.

In this case, in order to prevent the payment of improper advertisement costs and the interruption of a web service, which occur due to repeated clicks or repeated accesses of a competitor or a malicious user, the manager terminal 200 defines set information, including a specific period, the limit number of accesses within the specific period, operation scenarios for respective numbers of excessive accesses, weights for respective access paths, an Internet Protocol (IP) address area, and initialization time for the IP address area, and transmits the set information to the web stabilization server 400.

In this case, the definition of a weight for each access path is performed by defining a weight for each path through which a corresponding visitor terminal 100 accesses the web site provided by the web service server 300.

In this embodiment, it is preferable that a high weight be assigned to a visitor who accesses site A through a portal site search or keyword search, and a low weight be assigned to a visitor who accesses the site A through a link when accessing other sites.

For example, if the number of accesses of the visitor is accumulated and exceeds the limit number of accesses in the case where an advertiser sets an allowable click and access period for advertisement A to 3 hours to 7 days, and sets the limit number of accesses to the advertisement A, corresponding to the set information, to a minimum of 10 to a maximum of 100, the visitor terminal 100 can be moved to a specific page, or a warning notice window can be transmitted to the visitor terminal 100 on the basis of the operation scenarios for respective number of excessive accesses.

Accordingly, the manager terminal 200 can prevent the interruption of a web site service occurring due to the improper access of the web browser by a competitor or a malicious user.

That is, when a Denial of Service (DOS)/Distributed DoS (DDOS) attack on a specific site occurs, a continuous access is performed within a short period of time, so that visitors are arbitrarily blocked according to the defined set information, thus preventing access to the web site from being interrupted.

For reference, the term “IP address area” means a subnet mask for an Internet Protocol (IP) address, and subnetting sections for IP addresses can be classified according to respective bits. In addition, a method of calculating an IP address area is called the calculation of an IP address subnetting area, and available IP address areas for classes A, B, C, D, and E can be calculated according to the bit value of the IP address. Class A uses 255.0.0.0 as a default subnet mask and has values ranging from 0 to 126 as a first octet. For example, in an address 10.52.36.11, since a first octet 10 exists between 0 and 126, this address belongs to class A. Class B uses 255.255.0.0 as a default subnet mask and has values ranging from 128 to 191 as a first octet. Class C uses 255.255.255.0 as a default subnet mask and has values ranging from 192 to 223 as a first octet. Class D indicates addresses for multicasting and does not include a net ID and a host ID. Class E indicates addresses reserved for a special purpose.

Allocation of network address 192.168.123.0 belonging to class C means that addresses ranging from 192.168.123.1 to 192.168.123.254 can be used for 150 hosts. In the above example, 192.168.123.0 and 192.168.123.255 cannot be used because all of the values in a fourth octet, which is a host address field, cannot be ‘1’ or ‘0’. Address ‘0’ is useless because a network is specified while a host is not specified. Address ‘255 (11111111 in a binary format)’ is a broadcast address for broadcasting a message to all hosts on the network. A subnet mask 255.255.255.192 provides four networks, each having 62 hosts, which is expressed in 11111111.11111111.11111111.11000000 in a binary format. Therefore, since first two digits in the last octet indicate a network address, additional networks such as 00000000(0), 01000000(64), 10000000 (128), and 11000000 (192), are obtained.

That is, when a subnet mask 255.255.255.192 is used, a network 192.168.123.0 is divided into four networks, such as 192.168.123.0, 192.168.123.64, 192.168.123.128 and 192.168.123.192, and thus available host addresses are defined as the following addresses 192.168.123.1 to 62, 192.168.123.65 to 126, 192.168.123.129 to 190, and 192.168.123.193 to 254.

As described above, a binary host address in which all values are ‘1’ or ‘0’ is useless, and the first and last numbers cannot be used. Therefore, addresses with the last octet of 0, 63, 64, 127, 128, 191, 192, and 255 cannot be used.

For example, in the case of two addresses 192.168.123.71 and 192.168.123.133, when a subnet mask 255.255.255.0 belong to a default class C is used, the two addresses exist on the same network having an address 192.168.123.0. However, if a subnet mask 255.255.255.192 is used, the address 192.168.123.71 and the address 192.168.123.133 separately exist on the network having an address 192.168.123.64 and the network having an address 192.168.123.128, respectively.

Meanwhile, in this embodiment, the visitor terminals 100 and the manager terminal 200 are computer devices enabling communication and are set to include a portable telephone, a Personal Digital Assistant (PDA), a Portable multimedia player (PMP), and other terminals, which each have an Internet browser capable of displaying web content and each enable mobile communication and wireless Internet communication, in addition to a personal computer such as a notebook computer, but the present invention is not limited to this embodiment.

The web service server 300 posts information received from the manager terminal 200 on a web site, and thus provides a service.

In this case, the web service server 300 transmits information about a visitor terminal 100 which accesses the web site, that is, cookie information included in the web browser of the visitor, to the stabilization server 300, which will be described later.

In detail, the cookie information preferably includes an Internet Protocol (IP) address, IP address area information, the address of an accessed web site, access time (date), and the number of accesses to the web site.

Further, the stabilization server 400 runs a script for tracking and preventing abnormal clicks, compares cookie information with set information, creates new cookie information if a current visitor is a first-time visitor, determines whether a malicious click occurs if a current visitor is a returning visitor, and interrupting the access of a malicious visitor terminal 100 or forcibly connecting the visitor terminal to a specific site.

In detail, referring to FIG. 2b, the reception module unit 410 receives set information from the manager terminal 200 and cookie information, included in the web browser of the visitor, from the web service server 300.

The cookie information checking module unit 420 determines whether a malicious click occurs in the visitor terminal 100 on the basis of the cookie information and set information received through the reception module unit 410.

This operation is performed such that the cookie information determination module 421 determines whether the access of the visitor terminal is the access of a returning visitor by comparing the cookie information of the visitor terminal 100, which accesses the web site, with prestored set information, and such that the cookie information creation module 422 newly creates cookie information of the visitor terminal 100 if it is determined that the access of the visitor terminal 100 is the access of a first-time visitor. In other words, the cookie information determination module 421 preferably determines the coincidence of IP addresses.

In this case, if it is determined that the access of the visitor terminal 100 is not the access of a first-time visitor, the access number checking module 423 determines whether the number of accesses of the visitor terminal 100, included in the cookie information, exceeds the limit number of accesses within a specific period according to the condition of the predefined set information. When the number of accesses exceeds the limit number of accesses, the scenario operation module 424 executes an operation scenario corresponding to a weight for a corresponding access path and the exceeded number of accesses.

For example, in an access limitation condition of 50 times within 3 days, when a visitor terminal A 100 having A cookie information accesses a web site 60 times greater than 50 times within 3 days, a warning message is visually provided to the visitor terminal 100 through a pop-up window. When the visitor terminal A 100 accesses the web site 70 times, the visitor terminal is forcibly moved to a specific page.

Meanwhile, if the number of accesses included in the cookie information does not exceed the limit number of accesses within the specific period according to the condition of the predefined set information in the case where the access of the visitor terminal 100 is not the access of a first-time visitor, the cookie information recording module 425 records the cookie information of the visitor terminal 100 and the number of accumulative accesses.

Further, the cookie information recording module 425 preferably records cookie information that exceeds the limit number of accesses within the specific period, and the number of accumulative accesses that exceeds the limit number of accesses.

The IP address area comparison calculation module 426 calculates the bit rate of an IP address area on the basis of the IP address and IP address area information, included in the cookie information, and the predefined set information, thus identifying the visitor corresponding to the IP address area. That is, even through an IP address is changed or a cookie is deleted, the IP address area is tracked, thus determining an abnormal visitor.

For example, if an IP address has a subnet mask when it is 192.168.0.0 belonging to class C, 255.255.255.0 is 11111111.11111111.11111111.00000000 in a binary format. Since a subnet mask has a total of 28 bits, that is, 11111111.11111111.11111111.11000000, it becomes 255.255.255.192.

Accordingly, when a subnet is divided into 4 networks, the number of IP addresses assignable to each of 4 divided networks is 64. That is, it can be seen that 192.168.0.0 to 192.168.0.63 (first subnet), 192.168.0.64 to 192.168.0.127 (second subnet), 192.168.0.128 to 192.168.0.191 (third subnet), and 192.168.0.192 to 192.168.0.255 (fourth subnet) are obtained.

Therefore, all IP addresses belonging to the IP address area can be blocked.

For reference, as shown in FIG. 3, the bit rates of available IP address areas for IP address classes classified according to the bit value of an IP address composed of a total of 32 bits can be calculated. In this case, IP addresses can be classified into 5 classes, that is, A, B, C, D, and E according to characteristics.

It is apparent that the bit rates of the IP address areas calculated by the IP address area comparison calculation module 426 are recorded by the cookie information recording module 425.

The initialization module 427 operates a timer to initialize an IP address area having the number of accesses that exceeds the limit number of accesses within a specific period.

That is, the timer is set according to the value of the predefined initialization time for an IP address area. After the time set in the timer has elapsed from the operation of the timer, information about the IP address area is deleted from the cookie information recording module 425.

Therefore, the visitor management module 428 records detailed information about each visitor terminal 100 and transmits the detailed information to the manager terminal 200 so that the manager can separately manage a visitor terminal 100 having the number of accesses exceeding the limit number of accesses within a specific period, thus separately managing a normal visitor and an abnormal visitor.

For example, in the case of a real estate agent site, a real estate agent accesses the site 200 times during 7 days, and a normal person accesses the site 50 times during 3 days, so that the person and the real estate agent can be separately identified. Therefore, the management of a visitor inducing the intentional interruption of a corresponding web service is possible. That is, the IP address area of each person is traced, and the bit rate of a corresponding IP address area is calculated, so that, when an abnormal access occurs, an abnormal visitor is forcibly moved to a specific page or is provided with a warning notice window according to an operation scenario.

In this embodiment, the detailed information about the visitor terminal 100 is set to include an access time (date), an IP address and the number of accesses and is set to be transmitted through email, but the present invention is not limited to this embodiment.

The transmission module unit 430 transmits an operation scenario, corresponding to the case where the number of accesses exceeds the limit number of accesses within a specific period, to the web service server 300 so that the visitor terminal 100 can identify the operation scenario, and transmits detailed information about an abnormal visitor to the manager terminal 200.

The database module unit 440 functions to store the set information which is received from the manager terminal 200 and includes a specific period, the limit number of accesses within the specific period, operation scenarios for respective numbers of excessive accesses, weights for respective access paths, IP address areas, and initialization times for IP address areas, and cookie information which is received from the web service server 300 and includes an IP address, IP address area information, the address of an accessed web site, an access time (date), and the number of accesses.

Further, the control module unit 450 functions to control the reception module unit 410, the cookie information checking module unit 420, the transmission module unit 430 and the database module unit 440.

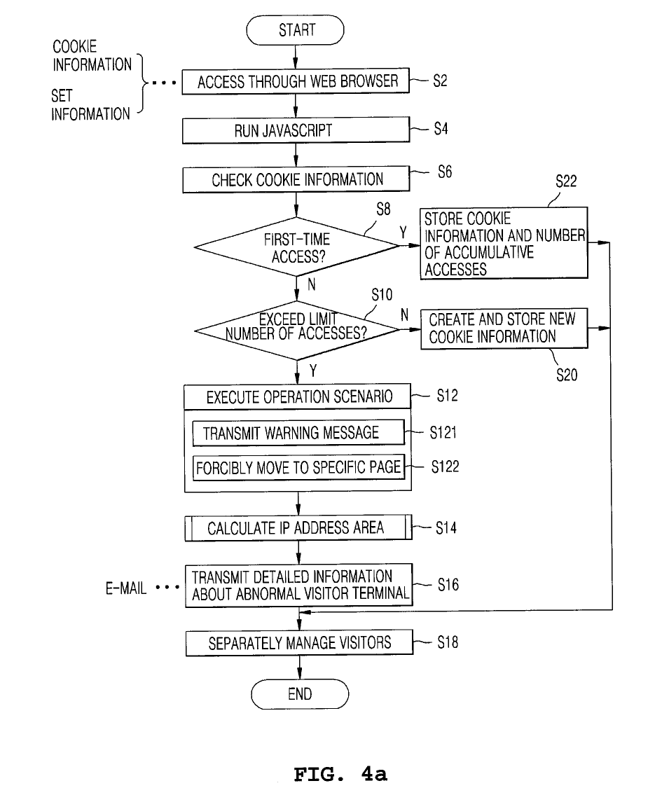

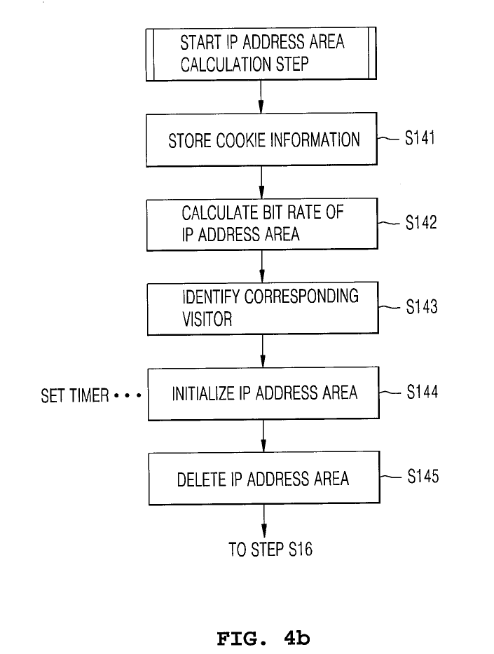

Hereinafter, the entire flow of a method of stabilizing a web service through the above-described system having the construction of FIG. 2 according to an embodiment of the present invention is described below with reference to FIGS. 4a and 4b.

FIG. 4a is an entire flowchart of a method of stabilizing a web service according to an embodiment of the present invention, and FIG. 4b is a detailed flowchart showing the step of calculating an IP address area according to an embodiment of the present invention.

First, as shown in FIG. 4a, when a visitor terminal 100 accesses a web site, provided by the manager terminal 200, through a web browser at step S2, the web stabilization server 400 runs a JavaScript at step S4.

In this case, before step S2, the manager terminal 200 for providing the web site to the visitor terminal 100 defines set information to prevent the payment of improper advertisement costs and the interruption of a web service occurring due to the repeated clicks or repeated accesses of a competitor or a malicious user to the web site.

The set information is defined to include a specific period, the limit number of accesses within the specific period, operation scenarios for respective numbers of excessive accesses, weights for respective access paths, IP address areas, and initialization times for the IP address areas, but the set information of the present invention is not limited to this example.

Next, the web stabilization server 400 checks the cookie information of the visitor terminal 100 which accesses the web service server 300 at step S6.

In this case, the cookie information preferably includes an IP address, IP address area information, the address of an accessed web site, an access time (date), and the number of accesses.

In detail, the web stabilization server 400 compares the cookie information with the set information, and thus determines whether the access of the visitor terminal 100 is the access of a first-time visitor at step S8.

In other words, it is determined whether the IP address included in the cookie information and the IP address area information thereof are recorded in the IP address area of the set information.

If it is determined that the access of the visitor terminal 100 is not the access of a first-time visitor at step S8, the web stabilization server 400 checks the limit number of accesses within the specific period, corresponding to the weight for each access path, and determines whether the number of accesses of the visitor terminal exceeds the limit number of accesses at step S10.

If it is determined that the number of accesses of the visitor terminal exceeds the limit number of accesses within the specific period at step S10, the web stabilization server 400 executes a corresponding operation scenario according to operation scenarios for respective numbers of excessive accesses at step S12.

For example, when the number of accesses exceeds the limit number of accesses, the scenario operation module 424 transmits a warning message to an abnormal visitor terminal 100 through a pop-up window at step S121, or forcibly moves the visitor terminal 100 to a specific page at step S122.

Next, the web stabilization server 400 calculates a corresponding IP address area corresponding to the predefined weight for each access path on the basis of the IP address and IP address area information of the abnormal visitor terminal 100, thus identifying the corresponding visitor at step S14.

The step S14 of identifying a corresponding visitor is described in detail with reference to FIG. 4b.

First, the web stabilization server 400 stores the cookie information of the abnormal visitor terminal 100 at step S141, and calculates the bit rate of the IP address area at step S142.

For example, in the case of 24 bit subnetting for a network 123.456.789.1, the number of possible IP addresses can be predicted as a total of 255 IP addresses ranging from 123.456.789.0 to 254. Therefore, in the case of 12 bit subnetting, half of the number of possible IP addresses is obtained. At this time, since the last number of the IP address is 1, IP addresses ranging from 123.456.789.0 to 127 are obtained by dividing the network by 12 bits.

The web stabilization server 400 identifies the corresponding visitor using the calculated bit rate of the IP address area at step S143. In this way, even though the IP address is changed, or a cookie is deleted, the corresponding visitor can be identified.

Next, the web stabilization server 400 sets a timer so as to initialize the IP address area of the identified abnormal visitor terminal 100 at step S144. In this case, the setting of time on the timer is performed to set the initialization time corresponding to the bit rate of the IP address area.

If the time on the timer, set at step S144, is initialized, the web stabilization server 400 deletes the IP address area information of the abnormal visitor terminal 100 at step S145.

Next, the web stabilization server 400 transmits the detailed information about the visitor terminal 100 having the number of accesses, exceeding the limit number of accesses within the specific period, to the manager terminal 200 at step S16, and separately manages a normal visitor and an abnormal visitor at step S18.

This embodiment shows the case where the detailed information about the visitor terminal 100 includes an access time (date), an IP address, the number of accesses, etc. and can be transmitted through email, but the present invention is not limited to this embodiment.

Meanwhile, if it is determined that the number of accesses does not exceed the limit number of accesses within the specific period at step S10, the web stabilization server 400 accumulates and stores the cookie information and the number of accesses of the visitor terminal 100 at step S20.

In contrast, if it is determined that the access of the visitor terminal 100 is the access of a first-time visitor at step at step S8, the web stabilization server 400 newly creates and stores the cookie information of the visitor terminal 100 at step S22.

Although the preferred embodiments of the present invention have been disclosed for illustrative purposes to describe the technical spirit of the present invention, those skilled in the art will appreciate that the present invention is not limited to the construction and operation described in the embodiments, and various modifications, additions and substitutions are possible, without departing from the scope and spirit of the invention as disclosed in the accompanying claims. Therefore, it should be noted that all appropriate modification, changes and equivalents belong to the scope of the present invention.

### INDUSTRIAL APPLICABILITY

As described above, the present invention is advantageous in that it sets the number of accumulative accesses within a specific period, so that the interruption of a web site service caused by the improper access of a competitor or a malicious user through the web browser thereof can be prevented, thus stabilizing a web service.

Further, the present invention is advantageous in that it calculates the bit rate of an IP address area to identify the visitor in the IP address area, thus identifying a corresponding visitor even though an IP address is changed or a cookie is deleted. This enables an abnormal visitor and a normal visitor to be separately managed.

1. A system for stabilizing a web service, the system including at least one visitor terminal (100), each running a web browser to access a web site over an information network (N), a management terminal (200) for managing the web site, a web service server (300) for providing a web site service to allow the visitor terminal to be provided with information, and a web stabilization server (400), wherein:
the web stabilization server (400) comprises:
a reception module unit (410) for receiving set information from the manager terminal, and cookie information, included in a web browser of a visitor, from the web service server (300);
a cookie information checking module unit (420) for determining whether a malicious click occurs in the visitor terminal using the cookie information and the set information;
a transmission module unit (430) for transmitting an operation scenario, corresponding to a case where a number of accesses exceeds a limit number of accesses within a specific period, to the web service server so that the visitor terminal can identify the operation scenario, and transmitting detailed information about an abnormal visitor to the manager terminal;
a database unit (440) for storing therein the set information received from the manager terminal and the cookie information received from the web service server; and
a control module unit (450) for controlling the components (410, 420, 430 and 440) to run a script for tracking and preventing abnormal clicks, comparing the cookie information with the set information, creating new cookie information when the visitor is a first-time visitor, determining whether a malicious click occurs when the visitor is a returning visitor, and interrupting access of the visitor terminal or forcibly connecting the visitor terminal to a specific site if it is determined that a malicious click occurs.

2. The system according to claim 1, wherein the manager terminal (200) defines the set information including a specific period, a limit number of accesses within the specific period, operation scenarios for respective numbers of excessive accesses, weights for respective access paths, Internet Protocol (IP) address areas, and initialization times for the IP address areas so as to prevent payment of improper advertisement costs and interruption of the web service occurring due to repeated clicks or repeated accesses of a competitor or a malicious user.

3. The system according to claim 1, wherein the cookie information includes an IP address, IP address area information, an address of an accessed web site, an access time (date), and a number of accesses to the web site.

4. The system according to claim 1, wherein the cookie information checking module unit (420) comprises:
a cookie information determination module (421) for determining whether an access of the visitor terminal to the web site is an access of a returning visitor, based on the cookie information and the set information;
a cookie information creation module (422) for newly creating cookie information of the visitor terminal when the access of the visitor terminal is an access of a first-time visitor;
a access number checking module (423) for determining whether the number of accesses included in the cookie information exceeds the limit number of accesses within the specific period according to a condition of the predefined set information when the access of the visitor terminal is not an access of a first-time visitor;
a scenario operation module (424) for executing an operation scenario, corresponding to a weight for an access path and a number of excessive accesses when the number of accesses exceeds the limit number of accesses through determination of the access number checking module;
an IP address area comparison calculation module (426) for calculating a bit rate of an IP address area based on the IP address and the IP address area information included in the cookie information and the predefined set information; and
an initialization module (427) for operating a timer to initialize an IP address area having the number of accesses exceeding the limit number of accesses within the specific period.

5. The system according to claim 4, wherein the cookie information checking module unit (420) further comprises a visitor management module (428) for recording detailed information about the visitor terminal, including an access time (date), an IP address, and the number of accesses and transmitting the detailed information to the manager terminal through email so that the manager can separately manage the visitor terminal having the number of accesses exceeding the limit number of accesses within the specific period, thus separately managing a normal visitor and an abnormal visitor.

6. The system according to claim 4, wherein the scenario operation module (424) executes a scenario for forcibly moving the visitor terminal to a specific page or visually providing a warning message through a pop-up window.

7. A method of stabilizing a web service using a system for stabilizing a web service, comprising the steps of:
(a) a web stabilization server (300) running a JavaScript by allowing a visitor terminal (100) to access a web service server (300);
(b) the web stabilization server checking cookie information of the visitor terminal, which accesses the web service server;
(c) the web stabilization server comparing the cookie information with set information, thus determining whether the access of the visitor terminal is an access of a first-time visitor;
(d) the web stabilization server checking a limit number of accesses within a specific period corresponding to a weight for an access path if it is determined that the access of the visitor terminal is not an access of a first-time visitor at step (c), and determining whether the number of accesses of the visitor terminal exceeds the limit number of accesses;
(e) the web stabilization server executing a corresponding operation scenario according to operation scenarios for respective numbers of excessive accesses if it is determined that the number of accesses exceeds the limit number of accesses within the specific period at step (d); and
(f) the web stabilization server calculating an IP address area corresponding to a preset weight for the access path using an IP address and IP address area information of an abnormal visitor terminal (100).

8. The method according to claim 7, further comprising, before the step (a), the step of a manger terminal (200) defining the set information required to prevent payment of improper advertisement costs and interruption of a web service.

9. The method according to claim 7, wherein the step (c) comprises the step of the web stabilization server accumulating and storing cookie information and the number of accesses of the visitor terminal if it is determined that the number of accesses of the visitor terminal does not exceed the limit number of accesses within the specific period.

10. The method according to claim 7, wherein the step (d) comprises the step of the web stabilization server newly creating and storing cookie information of the visitor terminal if it is determined that the access of the visitor terminal is the access of a first-time visitor at the step (c).

11. The method according to claim 7, wherein the step (e) comprises the steps of:
a scenario operation module (424) transmitting a warning message to an abnormal visitor terminal through a pop-up window; and
the scenario operation module forcibly moving the abnormal visitor terminal to a specific page.

12. The method according to claim 7, wherein the step (f) comprises the steps of:
(f-1) the web stabilization server storing cookie information of the abnormal visitor terminal;
(f-2) the web stabilization server calculating a bit rate of the IP address area;
(f-3) the web stabilization server identifying the corresponding visitor using the calculated bit rate of the IP address area; and
(f-4) the web stabilization server initializing the IP address area of the abnormal visitor terminal.

13. The method according to claim 12, wherein the step (f-4) comprises the steps of:
the web stabilization server setting a timer according to the IP address area of the abnormal visitor terminal; and
the web stabilization server deleting the IP address area information of the abnormal visitor terminal.

14. The method according to claim 7, further comprising, after the step (f), the steps of:
the web stabilization server transmitting detailed information about the visitor terminal having the number of accesses, exceeding the limit number of accesses within the specific period, to the manager terminal (200); and
the web stabilization server separately managing a normal visitor and the abnormal visitor.
